(19) United States
(12) Patent Application Publication
(10) Pub. No.: US 2003/0059252 A1
(43) Pub. Date: Mar. 27, 2003

(54) Set of metal bodies with rectilinear axis and constant cross section for making a cross for fixing vertical plates in point-supported suspended facades, and cross thus obtained

(76) Inventor: Carmen Gasparotto, Duino Aurisina (IT)

Correspondence Address: Lorusso & Loud, 3137 Mount Vernon Avenue, Alexandria, VA, 22305, US

(21) Appl. No.: 10/239,565

(22) PCT Filed: Mar. 27, 2001
(86) PCT No.: PCT/IB01/00496

(30) Foreign Application Priority Data
Mar. 27, 2000 (IT) MI2000A000641

(51) Int. Cl. F16B 12/36

(52) U.S. Cl. 403/293

(57) ABSTRACT

The present invention relates to a set of metal bodies having rectilinear axis and constant cross section, which, appropriately connected together, enable a cross with one, two, three, or four arms to be made for fixing vertical plates in point-supported continuous facades.

Forming the subject of the present invention is a set of metal bodies with rectilinear axis and constant cross section for making a member for the fixing and support of contiguous vertical plates in point-supported suspended facades.

A further subject of the present invention is a member for the fixing and support of vertical plates in point-supported suspended facades obtained by putting together said metal bodies with rectilinear axis and constant cross section.

For making point-supported suspended facades the possibility is known of using so-called crosses, i.e., members for fixing and supporting vertical plates, comprising a central hole for fixing the cross to a supporting structure (typically an upright) and, according to the number of vertical plates to be supported, from one to four arms provided at their ends with circular holes or slots for insertion of fixed or articulated joints, to which the corners of the plates to be supported are fixed.

According to the prior art, the crosses are made of light-alloy castings or by the stamping of steel.

In view of the need to have crosses with a variable number of arms and the need to provide both circular holes and slots for insertion of the articulations, it follows that it would be necessary to have in store a relatively large number of different types of crosses.

This would call for a large number of dies and would therefore involve high production costs.

In order to reduce the costs, it is preferred to produce only crosses with two or four arms and to cut off the excess arms as required. the purpose of broadcasting a signal to a subscriber unit. For example, a subscriber unit might be located behind an obstruction, with the result that a signal focused in the direction of maximum received signal strength, which is the perceived direction of the subscriber unit, is instead merely focused on an edge of the obstruction. A widely broadcast signal will more easily diffuse around the obstruction than a narrowly beamed signal and will have a better chance of reaching the subscriber unit than the beamed signal. Another situation where a focused beam is disadvantageous is when the subscriber unit is located in an environment where fading makes it exceedingly difficult to determine a location of the subscriber unit based on received signal strength. A beamed signal may end up being targeted in the wrong direction. Or a subscriber unit may be operating at a declining power level due to problems with the unit's power source and will not be able to acceptably receive a slightly misdirected beamed signal. Therefore, a need exists for a method and apparatus that provides a determination of when a situation is appropriate for employment of an antenna array beamforming technique.

### SUMMARY OF THE INVENTION

In a communication device that includes an antenna array including multiple antennas, the present invention provides a method and apparatus for optimizing a usage of an antenna array beamforming technique. In one embodiment, the communication device determines a bearing from the communication device to a communication unit and determines a direction of arrival of a signal received from the communication unit by the communication device via each of the multiple antennas. The communication device compares the bearing to the direction of arrival, determines a difference between the two, and compares the determined difference to a predetermined difference threshold. The communication device then determines whether to employ an antenna array beamforming technique based on the comparison of the determined difference to the predetermined difference threshold.

In an alternative embodiment, the communication device determines a distance between the

In addition, it is preferred to make only slotted openings on the arms, which can be enlarged subsequently if required to convert them into circular openings.

However, all these subsequent processes have a marked incidence on the total processing times, and hence on the final cost of the crosses, as well as on the general appearance of the cross.

The purpose of the present invention is therefore to propose a new system for making crosses for fixing and supporting plates, which is technically simple and which enables a reduction in production costs.

The above purpose is achieved by providing a set of metal bodies having a rectilinear axis and constant cross section, in accordance with the specifications of the independent Claims 1, 6, 7, and 10, and by providing a cross in accordance with the specifications of the independent Claim 11.

Particularly advantageous embodiments of the metal bodies used for making crosses may be obtained in conformance with the specifications of Claims 2, 3, 4, 5, 8 and 9.

A possible embodiment of the metal bodies with rectilinear axis and constant cross section and of the cross obtained by putting together said metal bodies with rectilinear axis and constant cross section in conformance with the specifications of the claims of the patent will now be described with reference to the attached plates of drawings, in which:

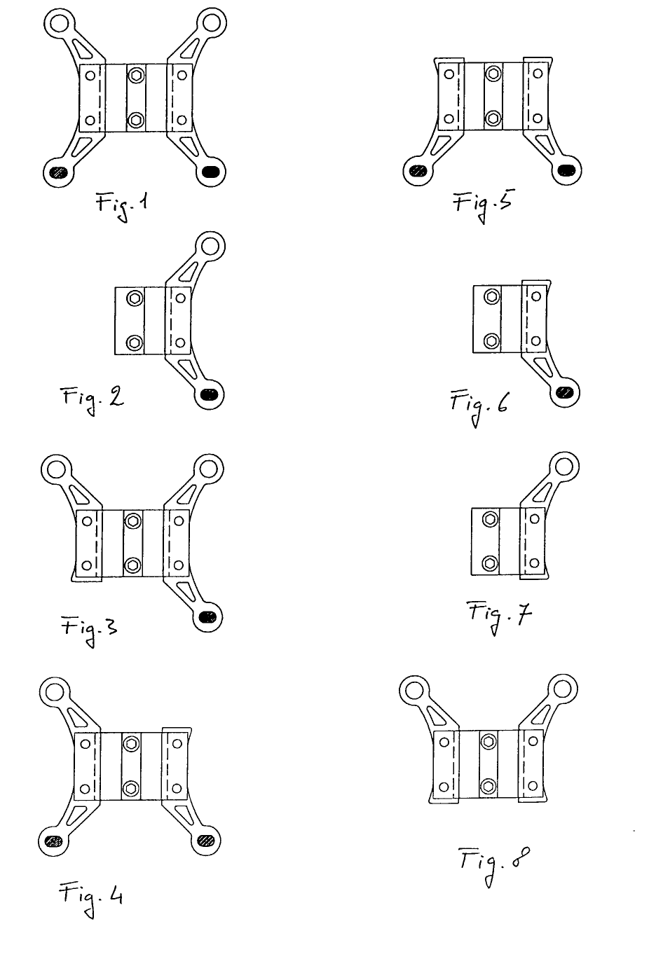

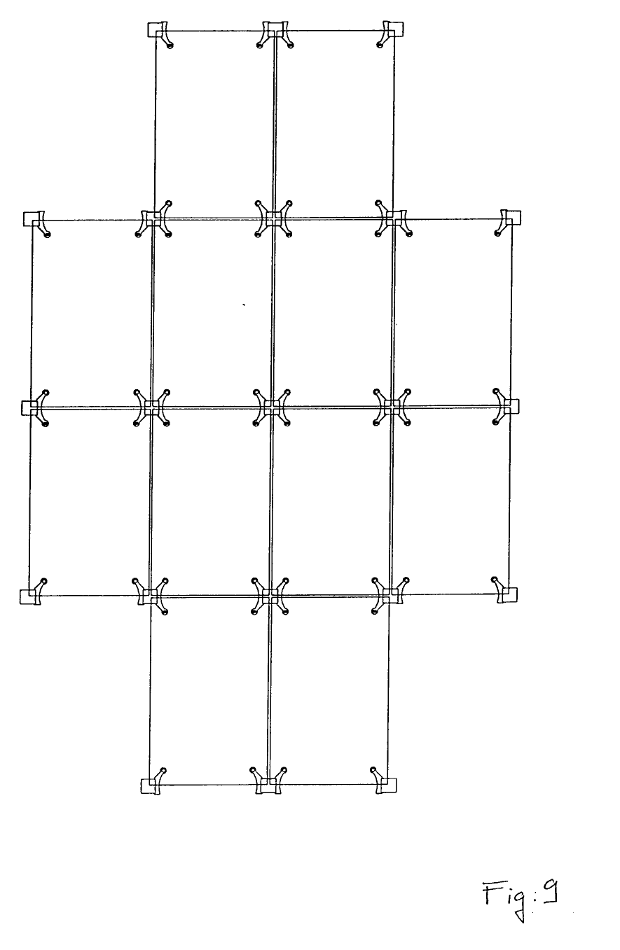

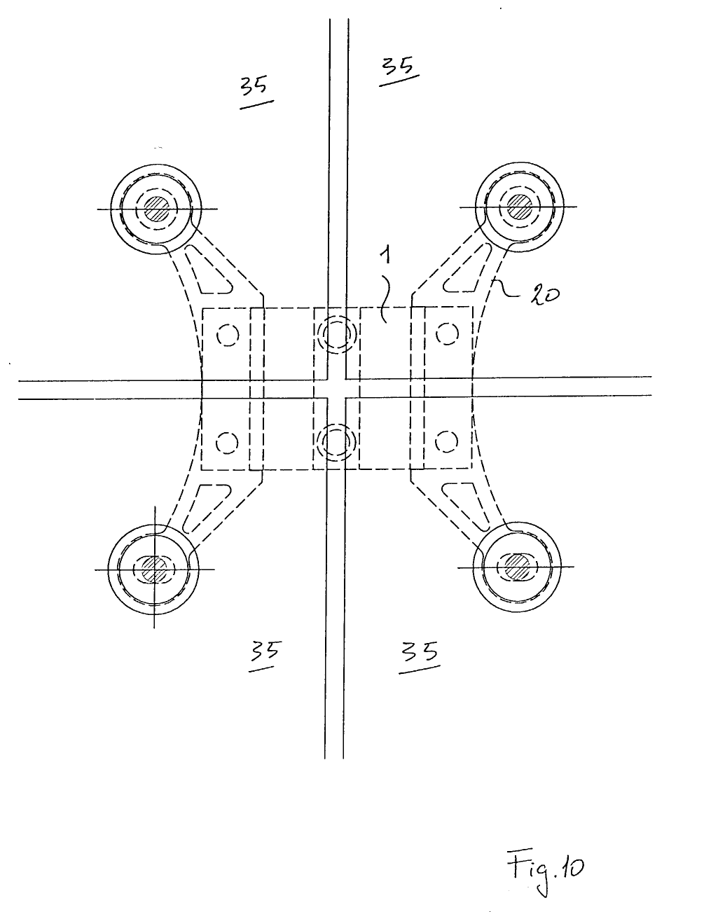

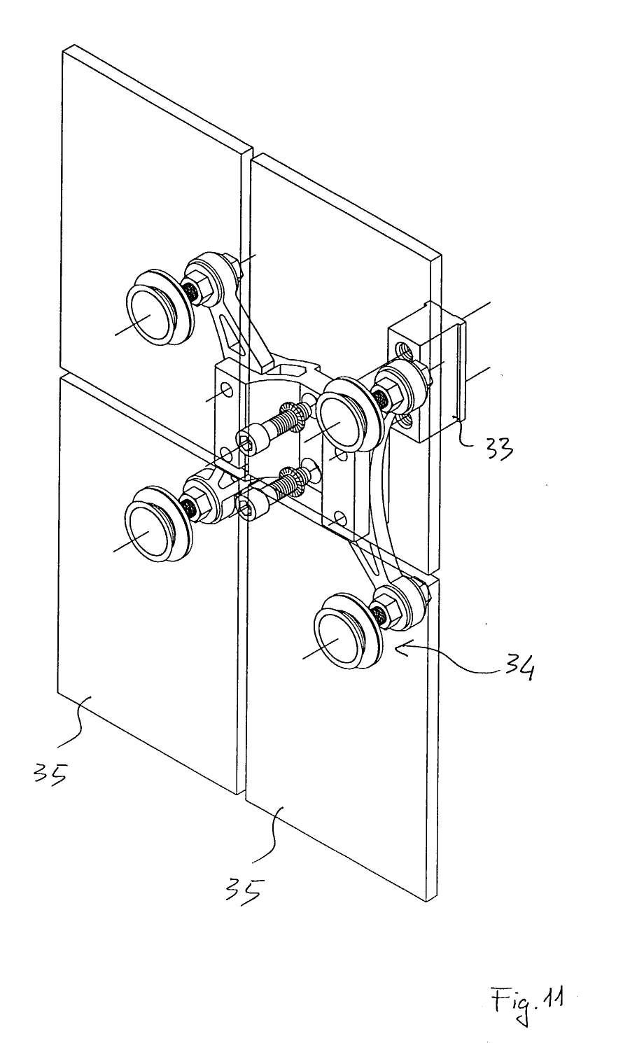

FIGS. 1-8 are schematic representations of some possible configurations of the cross that forms the subject of the present invention;

FIG. 9 is a schematic representation of a facade made using the crosses that form the subject of the present invention;

FIG. 10 shows an enlarged detail of the window intersection of the facade of FIG. 9;

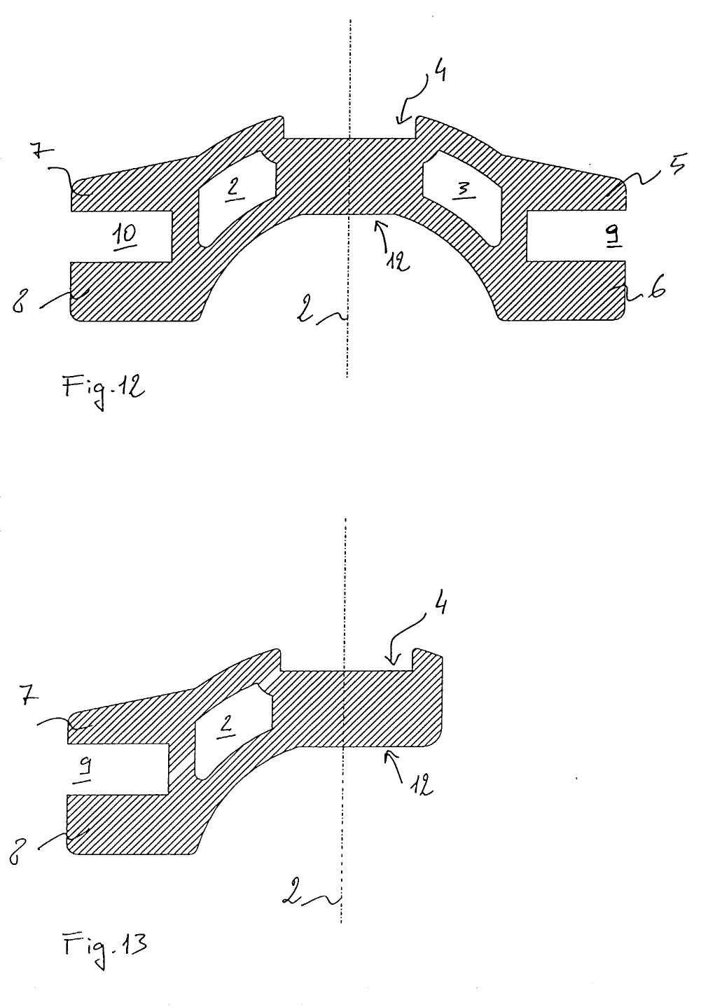

FIG. 11 is a perspective view of FIG. 10;

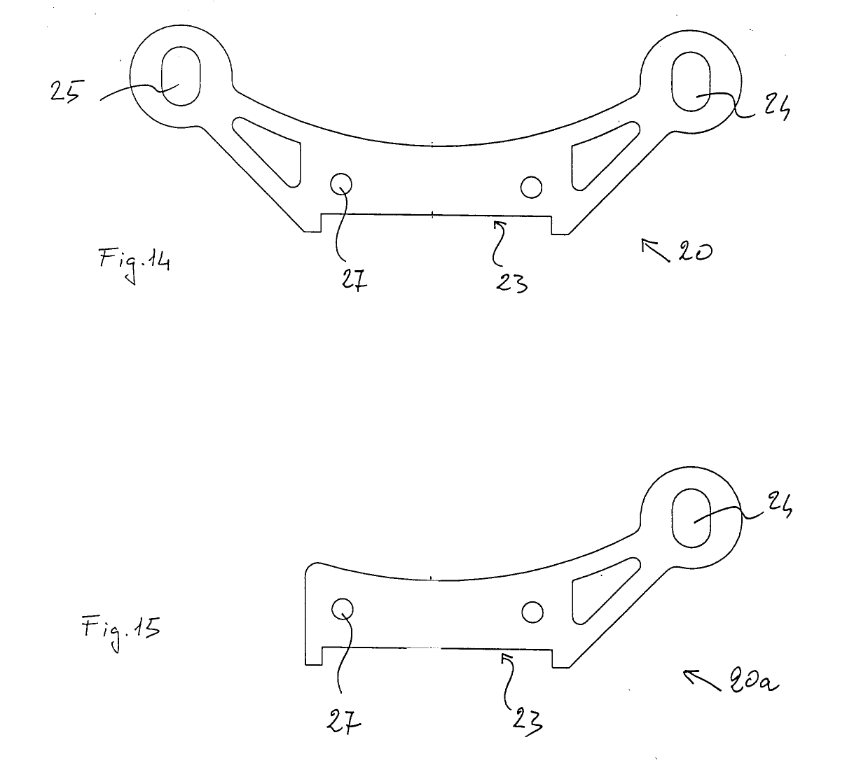

FIGS. 12 and 13 are cross-sectional views of two possible embodiments of a first extruded section used in making the support for the cross;

FIGS. 14 and 15 are cross-sectional views of two possible embodiments of a second extruded section used in making the arms the cross;

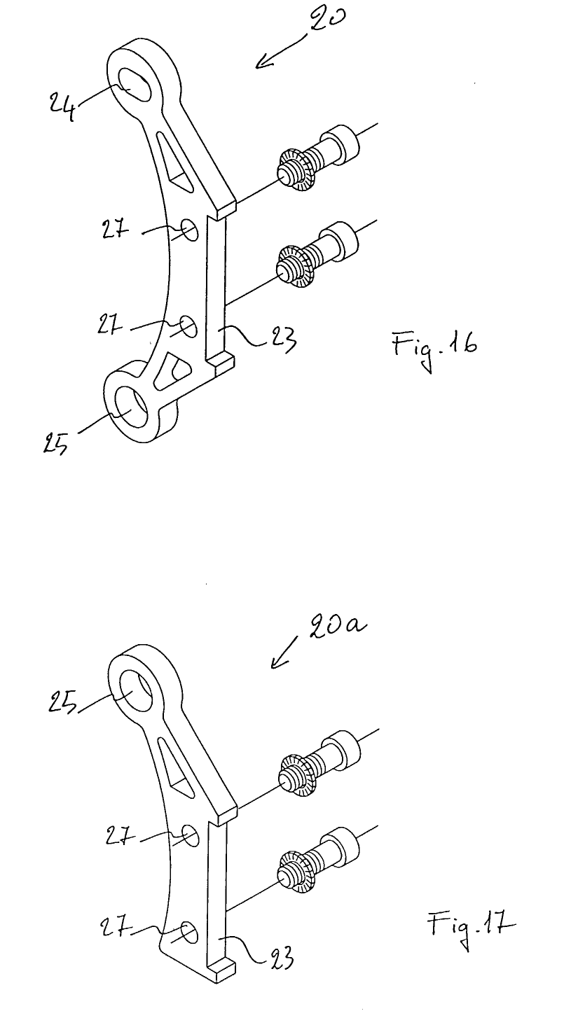

FIGS. 16 and 17 are two perspective views showing the same extruded section illustrated in FIGS. 14 and 15;

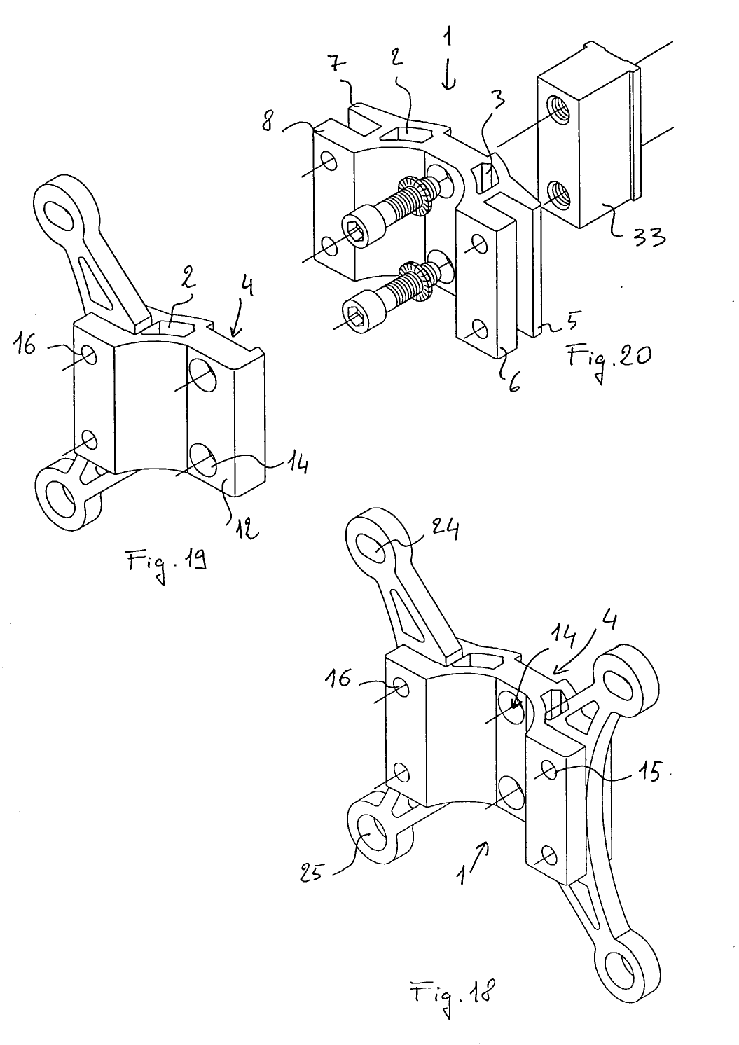

FIGS. 18 and 19 are two perspective views showing two possible embodiments of the cross; and

FIG. 20 shows a possible embodiment of the system for fixing the cross to a supporting upright.

With reference to the above-mentioned figures, the cross for fixing vertical plates in accordance with the invention comprises a central body, or cross support, 1, on which at least one arm 20 or 20a is mounted, designed to support a fixed or articulated joint.

The central body 1 is a metal body of an appropriate length with a rectilinear axis and constant cross section and presents a symmetrical profile with respect to an axis of symmetry 2 and has a generally omega shape (FIG. 12).

Preferably, the central body 1 is made as extruded section.

Of course, a person skilled in the art will be able to conceive, quite obviously, other solutions for making the central body 1, in particular stamping or pressure casting.

According to the embodiment illustrated, the section 1 has a plane surface 12 in an area corresponding to the concave bottom of the arched portion, an axial groove 4 in an area corresponding to the convex top of the arched portion, the said convex top having one or more through holes 14 aligned on the axis of symmetry 2, on each side of the arched portion, and two pairs of projecting flanges set on top of one another 5, 6 and 7, 8, which define two substantially rectangular grooves 9 and 10, on each pair of projecting flanges set on top of one another 5, 6 and 7, 8 there being provided one or more pairs of through holes 15, 16 set on top of one another.

Preferably, the through holes 14 have a portion of larger diameter in an area corresponding to the concave side of the arched portion of the section so as to enable insertion of the head of a screw.

In the embodiment illustrated, the section 1 has closed symmetrical cavities 2, 3 located in the arched portion of the section.

Preferably, one of the two through holes 15 or 16 set on top of one another of each pair of holes provided in each pair of projecting flanges set on top of one another 5, 6 and 7, 8 has a widened part designed to receive, at least partially, the head of a screw, whilst the other one of the two through holes set on top of one another 16 or 15 of each pair is threaded.

In the preferred embodiment, the axial groove 4 can be connected to a special foot or base 33, which is in turn designed to be inserted into an undercut groove of an appropriate supporting upright (not shown).

According to an alternative embodiment designated by the reference number 1a (FIG. 13), the omega section is modified in that one of the two pairs of projecting flanges 5, 6 or 7, 8 and part of the corresponding arched portion are missing.

The section of FIG. 1a will be used in the case where the cross is to support just one vertical plate, or else two plates set on top of one another.

The arm or arms 20 connected to the central body 1 are made up of metal bodies with a rectilinear axis and a constant cross section with a profile that is symmetrical with respect to an axis of symmetry 21.

According to the preferred embodiment, the arms 20 are made of extruded section; of course, a person skilled in the art will be able to conceive, quite obviously, other solutions, such as stamping or pressure casting.

According to the embodiment illustrated, the section 20 is generically crescent-shaped, cut to an appropriate length, and has one or more through holes 27 parallel to the rectilinear axis of the section and two eyelets 24, 25 one at either end of the crescent.

Preferably a groove 23 is provided in the convex top so as to enable slot-in connection with the omega-shaped support.

In practice, the section 20 constitutes a double arm which enables insertion of two fixed or articulated joints 34 for fixing and supporting plates 35.

Preferably, the eyelets 24, 25 have slots that extend parallel to the axis of symmetry 21; alternatively, at least one of the slots can be replaced with a circular opening.

In an alternative embodiment designated by 20a (FIGS. 15 and 17), the crescent-shaped section is modified in that one of the two eyelets 24 or 25 and one end part of the crescent are missing.

The single arm 20a will be used where the arm does not have to support more than one plate.

A person skilled in the art will immediately realise the advantages inherent in the solution described above.

In fact, with as few as four metal bodies of rectilinear axis and constant cross section (the supports 1 and 1a and the arms 20 and 20a) made, for example, as extruded section, it is possible to put together a wide range of crosses, which in effect cover all the types necessary for making a suspended facade of the point-supported type.

In the embodiment illustrated herein, connecting screws are provided between the arms 20, 20a and the pairs of flanges 5, 6 and 7, 8 of the omega section; of course, a person skilled in the branch will be able to conceive, quite obviously, the use of other connecting members.

1. A metal body (1) with rectilinear axis and constant cross section, with symmetrical profile with respect to an axis of symmetry (2), having a general omega shape and presenting:
an axial groove (4) at the convex top of the arched portion, said convex top having one or more through holes (14) aligned on the axis of symmetry (2); and
on each side of the arched portion, two projecting flanges (5, 6 and 7, 8) set on top of one another which define two substantially rectangular grooves (9 and 10), there being provided on each pair of projecting flanges set on top of one another (5,6 and 7, 8) one or more pairs of through holes (15, 16) set on top of one another.

2. The metal body with rectilinear axis and constant cross section, according to claim 1, in which a plane surface (12) is present at the concave bottom of the arched portion.

3. The metal body with rectilinear axis and constant cross section, according to claim 1 or claim 2, in which closed symmetrical cavities (2, 3) are present, which are located in the arched portion of the section.

4. The metal body with rectilinear axis and constant cross section, according to any one of claims 1 to 3, in which the through holes (14) aligned on the axis of symmetry (14) have a portion of a larger diameter in an area corresponding to the concave side of the arched portion of the section, so as to enable insertion of the head of a screw.

5. The metal body with rectilinear axis and constant cross section, according to any one of claims 1 to 5, in which one of the two through holes (15 or 16) set on top of one another of each pair of holes set on top of one another in each pair of flanges set on top of one another (5, 6 and 7, 8) has a widened part that is designed to receive, at least partially, the head of a screw, and in which the other of the two through holes (16 or 15) set on top of one another of each pair is threaded.

6. The metal body with rectilinear axis and constant cross section, according to any one of claims 1 to 5, modified in that one of the two pairs of projecting flanges (5,6 or 7, 8) and part of the corresponding arched portion are missing.

7. A metal body (20) with rectilinear axis and constant cross section, with symmetrical profile with respect to an axis of symmetry (21), having a generic crescent-like shape, and having:
one or more through holes (27) substantially parallel to said rectilinear axis; and
two eyelets (24, 25), one at either end of the crescent.

8. The metal body with rectilinear axis and constant cross section, according to claim 7, in which a groove (23) is provided in an area corresponding to the convex top.

9. The metal body with rectilinear axis and constant cross section, according to claim 7 or claim 8, in which at least one of said eyelets (24, 25) has a slot that extends parallel to the axis of symmetry (21).

10. The metal body with rectilinear axis and constant cross section, according to claim 6 or 7 or 8, modified in that one of the two eyelets (24 or 25) and one end part of the crescent are missing.

11. A cross for fixing vertical plates, comprising a support consisting of a metal body in conformance with the specifications of claim 1, or 2, or 3, or 4, or 5, or 6, mechanically joined to at least one arm consisting of a metal body in conformance with the specifications of any one of claims 7, 8, 9, and 10.
